(19) United States
(12) Patent Application Publication
(10) Pub. No.: US 2018/0247061 A1
(43) Pub. Date: Aug. 30, 2018

(54) IMAGE PROCESSING APPARATUS, PRINT SYSTEM, AND NON-TRANSITORY COMPUTER READABLE MEDIUM

(71) Applicant: FUJI XEROX CO., LTD., Tokyo (JP)

(72) Inventor: Mamoru MOCHIZUKI, Kanagawa (JP)

(73) Assignee: FUJI XEROX CO., LTD., Tokyo (JP)

(21) Appl. No.: 15/805,737

(22) Filed: Nov. 7, 2017

(30) Foreign Application Priority Data
Feb. 27, 2017 (JP) 2017-034420

(51) Int. Cl. G06F 21/60; G06F 3/12; H04L 9/08

(52) U.S. Cl. CPC G06F 21/608; G06F 3/1274; G06F 2221/2107; G06F 3/1222; H04L 9/08

(57) ABSTRACT

An image processing apparatus includes a nonvolatile storage unit, an acceptance unit, a conversion unit, and a controller. The nonvolatile storage unit stores data. The acceptance unit accepts a print instruction including image data. The conversion unit converts the image data to print data that is used when a print process is performed. The controller performs control, in a case where the print instruction accepted by the acceptance unit includes a setting indicating that data is to be deleted so as to be unrecoverable, to encode the image data and the print data obtained as a result of conversion by the conversion unit by using encryption key information and to store the image data and the print data in the storage unit.

### CROSS-REFERENCE TO RELATED APPLICATIONS

This application is based on and claims priority under 35 USC 119 from Japanese Patent Application No. 2017-034420 filed Feb. 27, 2017.

### Background

### (i) Technical Field

The present invention relates to an image processing apparatus, a print system, and a non-transitory computer readable medium.

### (ii) Related Art

In a case of performing a print process in an image processing apparatus, such as a copier or a printer, on the basis of a print job (print instruction), image data included in the print job or print data generated for performing the print process are once stored in a nonvolatile storage device, such as a hard disk drive (HDD). Accordingly, after completion of the print process, it is requested to erase the image data and the print data stored in the nonvolatile storage device in the image processing apparatus from the viewpoint of protecting information from being compromised.

### SUMMARY

According to an aspect of the invention, there is provided an image processing apparatus including a nonvolatile storage unit, an acceptance unit, a conversion unit, and a controller. The nonvolatile storage unit stores data. The acceptance unit accepts a print instruction including image data. The conversion unit converts the image data to print data that is used when a print process is performed. The controller performs control, in a case where the print instruction accepted by the acceptance unit includes a setting indicating that data is to be deleted so as to be unrecoverable, to encode the image data and the print data obtained as a result of conversion by the conversion unit by using encryption key information and to store the image data and the print data in the storage unit.

### BRIEF DESCRIPTION OF THE DRAWINGS

An exemplary embodiment of the present invention will be described in detail based on the following figures, wherein:

FIG. 1 is a diagram illustrating a system configuration of a print system according to an exemplary embodiment of the present invention;

FIG. 2 is a block diagram illustrating a hardware configuration of a controller according to an exemplary embodiment of the present invention;

FIG. 3 is a block diagram illustrating a functional configuration of the controller according to an exemplary embodiment of the present invention;

FIG. 4 is a flowchart for describing a process performed in the controller according to an exemplary embodiment of the present invention when file data is saved;

FIG. 5 is a diagram for describing a case where an encryption key generation unit generates an encryption key of 64 KB;

FIG. 6A is a diagram for describing an encoding process in which an exclusive OR operation (XOR) is performed for a data file and an encryption key to generate encoded data, and FIG. 6B is a diagram for describing a decoding process in which an exclusive OR operation is performed for the encoded data and the encryption key to generate the original data file;

FIGS. 7A and 7B are diagrams for describing a method in which an exclusive OR operation is performed in a case where the data length of encoding-target data is different from the data length of an encryption key;

FIG. 8 is a diagram for describing a process that is performed when data is written to a hard disk drive (HDD);

FIG. 9 is a diagram for describing a process that is performed when data is read from the HDD;

FIG. 10 is a diagram for describing a process that is performed when image data, intermediate data, and raster data are written to the HDD;

FIG. 11 is a diagram for describing a process that is performed when a print process is performed in a print apparatus using raster data spooled in the HDD;

FIG. 12 is a flowchart for describing a process in which a deletion process for deleting complete-deletion-target data from the HDD is performed after completion of a print process;

FIG. 13 is a diagram for describing a deletion process that is performed when encoded image data, encoded intermediate data, encoded raster data, and an encryption key stored in the HDD are deleted;

FIG. 14 is a diagram for describing a case where an encryption key is kept in a server apparatus that is an external apparatus; and

FIG. 15 is a diagram illustrating an example case where an encryption key is output to a sheet as a two-dimensional code.

### DETAILED DESCRIPTION

Hereinafter, an exemplary embodiment of the present invention will be described in detail with reference to the drawings.

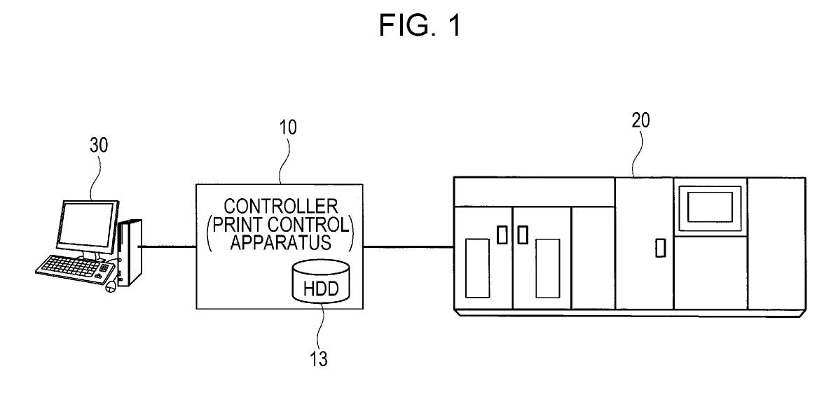

FIG. 1 is a diagram illustrating a system configuration of a print system according to an exemplary embodiment of the present invention.

As illustrated in FIG. 1, the print system according to an exemplary embodiment of the present invention includes a print apparatus (image forming apparatus) 20 for commercial use, a controller (print control apparatus) 10 for controlling a print process in the print apparatus 20, and a terminal apparatus 30 for transmitting a print job (print instruction) to the controller 10.

The controller 10 includes a hard disk drive (HDD) 13, which is a nonvolatile storage device for storing various types of data, such as image data of print content and print data that is transmitted to the print apparatus 20 for performing a print process. The controller 10 functions as an image processing apparatus that generates raster data to be transferred to the print apparatus 20 on the basis of a print job from the terminal apparatus 30.

In a case of performing a print process, the terminal apparatus 30 transmits a print job to the controller 10 to instruct the controller 10 to perform a print process. The controller 10 generates, on the basis of the print job from the terminal apparatus 30, raster data that is used to perform a print process, and transmits the raster data to the print apparatus 20. The print apparatus 20 forms an image on a recording medium, such as a print sheet, on the basis of print data generated in the controller 10 to thereby perform the print process.

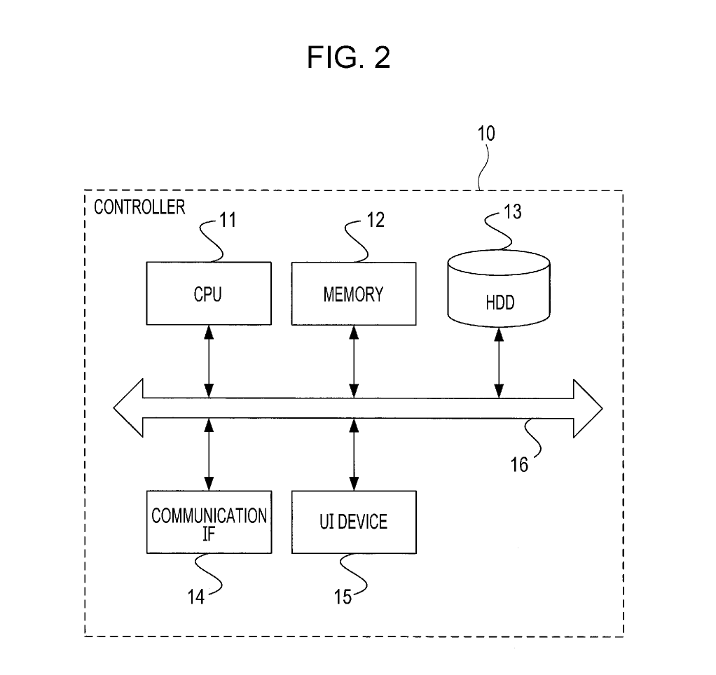

The hardware configuration of the controller 10 in the print system according to this exemplary embodiment is illustrated in FIG. 2.

As illustrated in FIG. 2, the controller 10 includes a central processing unit (CPU) 11, a memory 12, the HDD 13, a communication interface (IF) 14 for transmitting/receiving data to/from, for example, an external apparatus via a network, and a user interface (UI) device 15, which includes a touch panel or a liquid crystal panel and a keyboard. These constituent elements are connected to one another via a control bus 16.

The CPU 11 performs a predetermined process on the basis of a control program stored in the memory 12 or the HDD 13 to control operations of the controller 10. This exemplary embodiment is described under the assumption that the CPU 11 reads and executes the control program stored in the memory 12 or the HDD 13; however, the control program may be stored in a storage medium, such as a compact disc read-only memory (CD-ROM), and provided to the CPU 11.

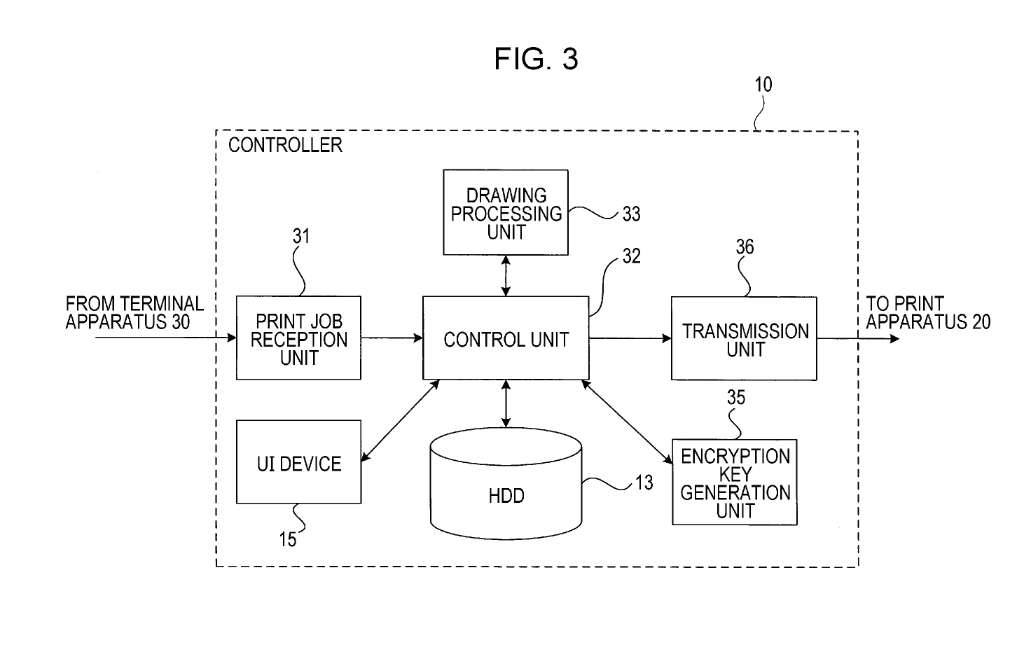

FIG. 3 is a block diagram illustrating a functional configuration of the controller 10 that is implemented when the control program described above is executed.

As illustrated in FIG. 3, the controller 10 according to this exemplary embodiment includes a print job reception unit 31, a control unit 32, a drawing processing unit 33, the UI device 15, the HDD 13, an encryption key generation unit 35, and a transmission unit 36.

The print job reception unit 31 communicates with the terminal apparatus 30 to accept a print job that includes image data from the terminal apparatus 30.

The control unit 32 first converts image data included in a print job received by the print job reception unit 31 to intermediate data (print data in an intermediate format). Thereafter, the control unit 32 causes the drawing processing unit 33 to perform a drawing process for the intermediate data to convert the intermediate data to raster data (image data in a raster format). The control unit 32 sequentially stores the print job from the print job reception unit 31, the intermediate data generated on the basis of the print job, and the raster data generated on the basis of the intermediate data in the HDD 13.

The control unit 32 transmits the raster data stored in the HDD 13 to the print apparatus 20 via the transmission unit 36 to thereby perform a print process.

The drawing processing unit 33 performs a drawing process (raster image processing (RIP)) for converting intermediate data to raster data in accordance with control by the control unit 32. That is, the drawing processing unit 33 converts image data to print data that is used when a print process is performed. The drawing processing unit 33 may perform a process for converting image data to intermediate data. Accordingly, it is assumed that print data described herein includes both raster data and intermediate data.

The encryption key generation unit 35 generates an encryption key (encryption key information) that is used to encode data in a case where a print job accepted by the print job reception unit 31 includes a setting indicating that data is to be deleted so as to be unrecoverable. In a description given below, a print job that includes a setting indicating that data is to be deleted so as to be unrecoverable is referred to as a print job that is a complete-deletion target.

The control unit 32 performs control to encode image data and print data, such as intermediate data and raster data, obtained as a result of conversion by the drawing processing unit 33 by using the encryption key generated by the encryption key generation unit 35 and to store the encoded image data and print data in the HDD 13 together with the encryption key.

In a case of deleting the print data and the image data stored in the HDD 13, the control unit 32 deletes the print data and the image data by using a usual deletion method and deletes the encryption key so as to be unrecoverable.

The control unit 32 may perform the process for deleting the image data and the print data and the process for deleting the encryption key at different timings.

The control unit 32 stores an encryption key generated by the encryption key generation unit 35 in the HDD 13 and, in a case of reading image data or print data stored in the HDD 13, uses the encryption key stored in the HDD 13 to decode the image data or the print data.

In this exemplary embodiment, a description is given under the assumption that an encryption key is stored in the HDD 13 together with encoded image data and so on. The control unit 32 may save an encryption key generated by the encryption key generation unit 35 in a location external to the controller 10 and, in a case of reading image data or print data stored in the HDD 13, may obtain the encryption key information saved in the location external to the controller 10 and decode the image data or the print data.

For example, the control unit 32 outputs an encryption key generated by the encryption key generation unit 35 to a sheet as a two-dimensional code image, such as a QR code (registered trademark) and, in a case of reading image data or print data stored in the HDD 13, obtains encryption key information from image data obtained by reading the two-dimensional code image and decodes the image data or the print data.

In a case where a print job includes a setting indicating that data is to be deleted so as to be unrecoverable, the control unit 32 assumes that image data included in the print job and print data generated are targets that are to be deleted so as to be unrecoverable and that print setting information included in the print job is not a target that is to be deleted so as to be unrecoverable.

In this exemplary embodiment, the control unit 32 performs an exclusive OR operation (XOR) for an encryption key and image data or for an encryption key and print data to thereby encode the image data or the print data. Further, the control unit 32 performs again an exclusive OR operation for the encryption key and the encoded image data or for the encryption key and the encoded print data to thereby perform a decoding process.

Here, an operation of deleting (completely deleting) data stored in the HDD 13 so as to be unrecoverable is an operation using an erase method, such as an erase method compliant with the US Department of Defense standard (DoD 5220.22-M) in which erase target data is overwritten plural times, so that it is hardly possible to recover data written to the HDD 13 even if an attempt to recover the data is made.

For example, the erase method compliant with the US Department of Defense standard (DoD 5220.22-M) is an erase method in which, in a case of erasing data, three steps of write processes, namely, overwriting the erase target data with all-bit-off data (0x00), overwriting the erase target data with all-bit-on data (0xFF), and overwriting the erase target data with random numbers, are performed. However, if data is deleted so as to be unrecoverable by using such an erase method, data deletion takes long, which is a shortcoming.

Meanwhile, the usual erase method for erasing data from the HDD 13 is an erase method in which only management information regarding an erase target data file is deleted. Therefore, even if an attempt to read erased data from the HDD 13 is made, it is not possible to recognize the presence of the data. However, the actual data file remains in the HDD 13, and it is possible to recover the erased data by using, for example, dedicated software. If the usual erase method is used, only management information needs to be deleted, and therefore, the time taken to perform the erase process is short.

Now, operations of the controller 10 according to this exemplary embodiment are described in detail with reference to the drawings.

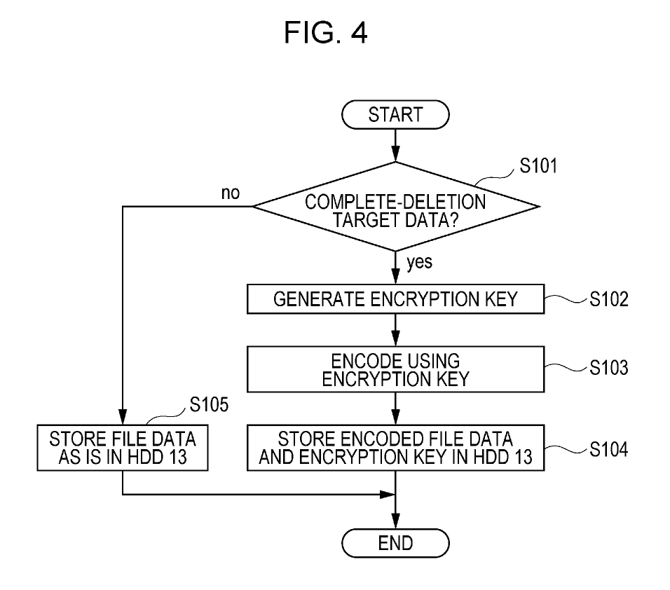

A process that is performed by the controller 10 according to this exemplary embodiment when file data is saved is described with reference to the flowchart in FIG. 4.

The control unit 32 determines whether file data to be saved in the HDD 13 is complete-deletion target data based on a print job that includes a setting indicating that data is to be deleted so as to be unrecoverable (step S101).

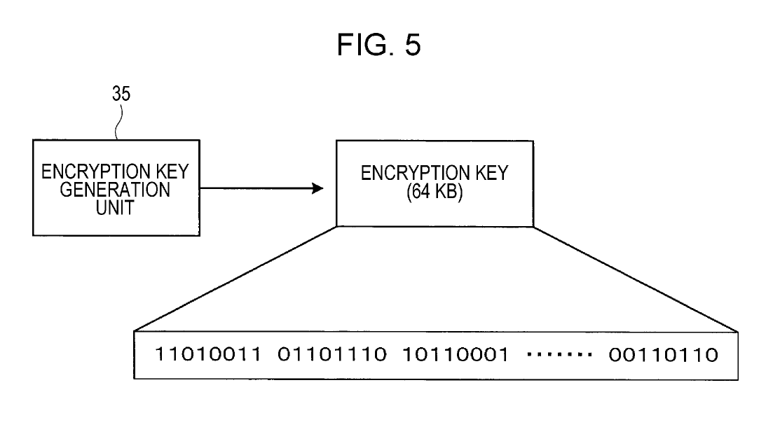

If file data to be saved in the HDD 13 is complete-deletion target data (yes in step S101), the control unit 32 controls the encryption key generation unit 35 to generate an encryption key as illustrated in FIG. 5 (step S102).

FIG. 5 illustrates a case where, for example, an encryption key of 64 KB (kilobytes) is generated.

Here, the data length of an encryption key need not be 64 KB, and an encryption key needs to have a data length of 1 byte or more. As the data length of an encryption key increases from 1 byte to 4 bytes and from 4 bytes to 8 bytes, for example, the security level increases. In a case of generating an encryption key, any information, such as random numbers or time information, may be used to generate an encryption key. For example, the job ID of the print job, time information, the name of the print job, and random numbers may be combined to generate encryption key information. Further, any value input by a user may be combined with various types of information described above to generate an encryption key.

If different encryption keys are generated for respective print jobs, the highest security is provided. However, the same encryption key may be used during, for example, a period from the time when the apparatus is turned on until the time when the apparatus is turned off in accordance with a requested security level. Alternatively, different encryption keys need not be generated for respective print jobs, and an encryption key may be generated for plural print jobs. Further, information, such as a one-time password, generated by an external apparatus may be used as encryption key information.

The control unit 32 uses the encryption key generated by the encryption key generation unit 35 to encode the file data to be saved in the HDD 13 (step S103). Specifically, the control unit 32 performs an exclusive OR operation for the encryption key generated by the encryption key generation unit 35 and the file data to be saved in the HDD 13 to perform an encoding process.

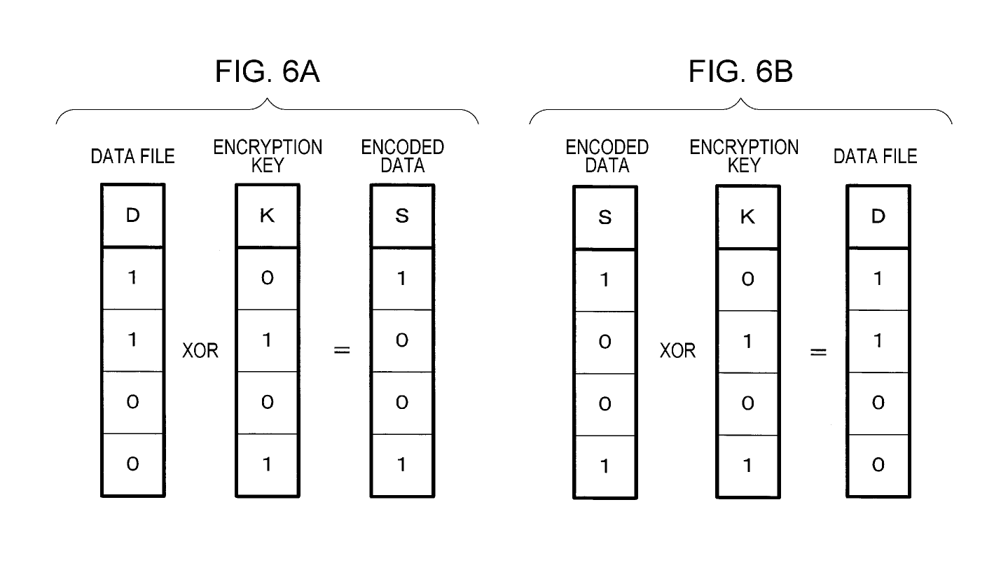

A specific arithmetic process in an encoding process in which an exclusive OR operation (XOR) is performed for the bits of a data file and the bits of an encryption key to generate encoded data is illustrated in FIG. 6A. A specific arithmetic process in a decoding process in which an exclusive OR operation (XOR) is performed for the bits of the encoded data and the bits of the encryption key to generate the original data file is illustrated in FIG. 6B.

As illustrated in FIG. 6A and FIG. 6B, an encoding process for a data file and a decoding process for the encoded data file are implemented by performing a simple logical operation with the same encryption key.

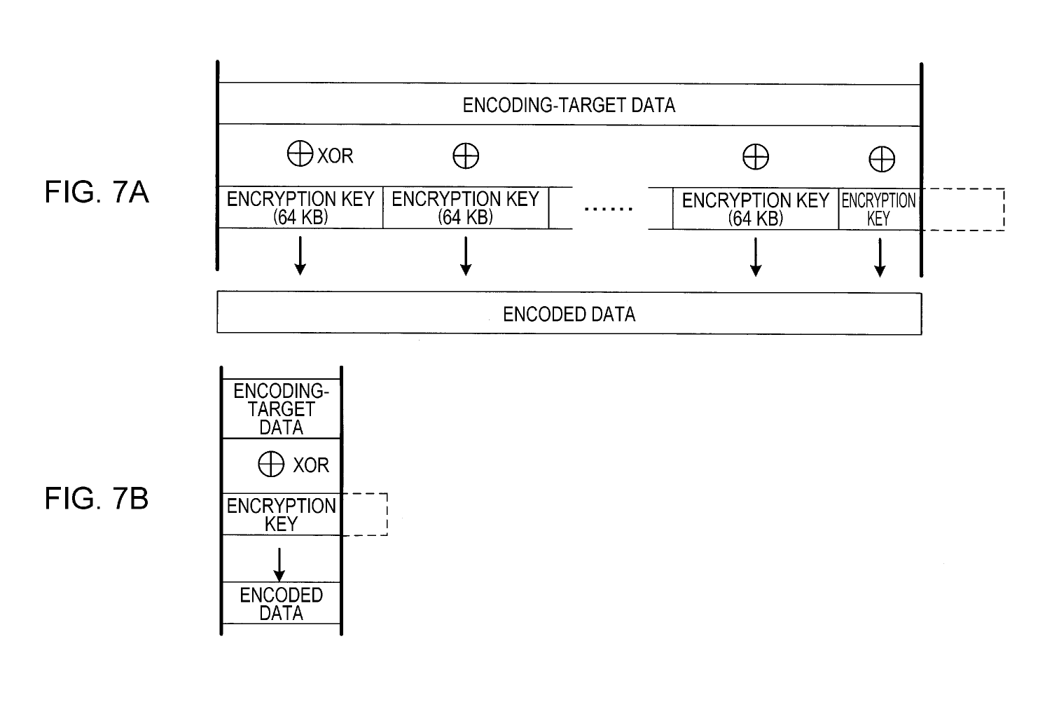

The data length of file data to be encoded (encoding-target data) is not necessarily equal to the data length of the encryption key. Even in a case where the data length of one of the file data and the encryption key is longer than the data length of the other, it is possible to perform an encoding process and a decoding process by performing processes as illustrated in FIGS. 7A and 7B. In FIGS. 7A and 7B, cases of an encoding process are illustrated for simplifying a description; however, it is also possible to perform a decoding process by using a similar method.

For example, in a case of an encryption key of 64 KB and encoding-target data of 64 KB or more, the encryption key of 64 KB is repeatedly used to perform an exclusive OR operation sequentially, as illustrated in FIG. 7A. In a case where a fraction remains in the end, an exclusive OR operation is performed for data of the fraction and data of part of the encryption key.

In a case of an encryption key of 64 KB and encoding-target data of less than 64 KB, an exclusive OR operation is performed for the encoding-target data and data of part of the encryption key, as illustrated in FIG. 7B.

Last, the control unit 32 stores the encoded file data and the encryption key in the HDD 13 (step S104).

If file data to be saved in the HDD 13 is not complete-deletion target data (no in step S101), the control unit 32 stores the file data in the HDD 13 as is without encoding the file data (step S105).

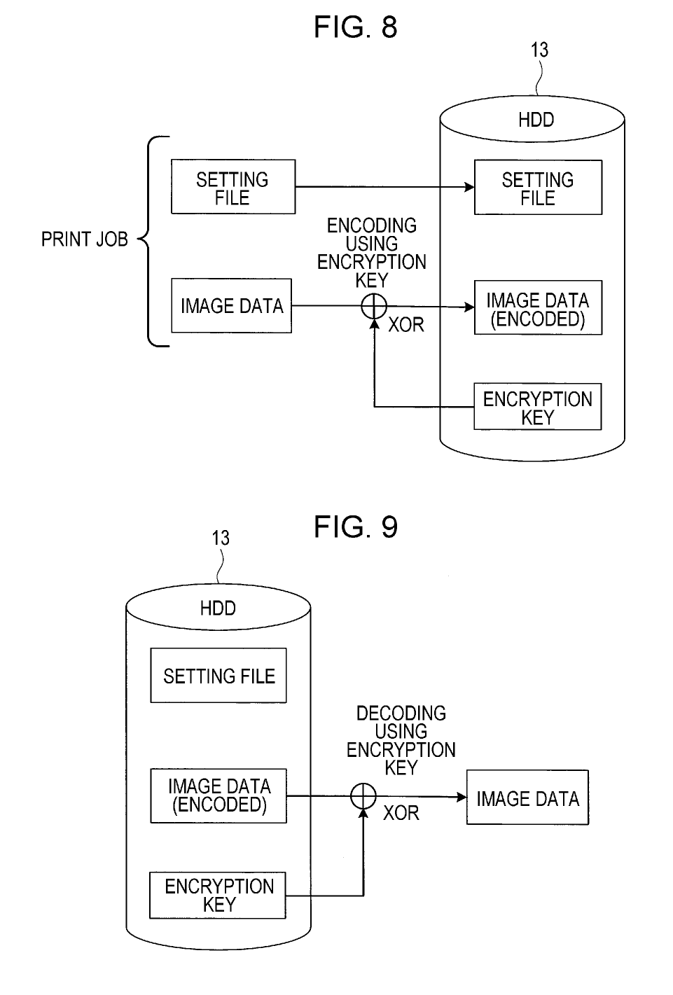

A process that is performed when data is written to the HDD 13 as described above is described with reference to FIG. 8. FIG. 8 illustrates a case where, among a setting file and image data included in a print job, an encoding process is performed only for the image data, and the setting file and the image data are stored in the HDD 13.

As illustrated in FIG. 8, in a case of storing image data included in a print job in the HDD 13, an exclusive OR operation is performed by using an encryption key, and the image data, which is encoded, is stored.

A process that is performed when the image data, which is thus encoded and stored in the HDD 13, is read is described with reference to FIG. 9. As illustrated in FIG. 9, the encoded image data stored in the HDD 13 is read, and an exclusive OR operation is performed by using an encryption key to thereby perform a decoding process for recovering the original image data.

The process that is performed when image data included in a print job is written to the HDD 13 and the process that is performed when the written image data is read are described with reference to FIG. 8 and FIG. 9, respectively. In a case of writing print data, such as intermediate data or raster data, to the HDD 13 and in a case of reading the written print data, similar processes are performed.

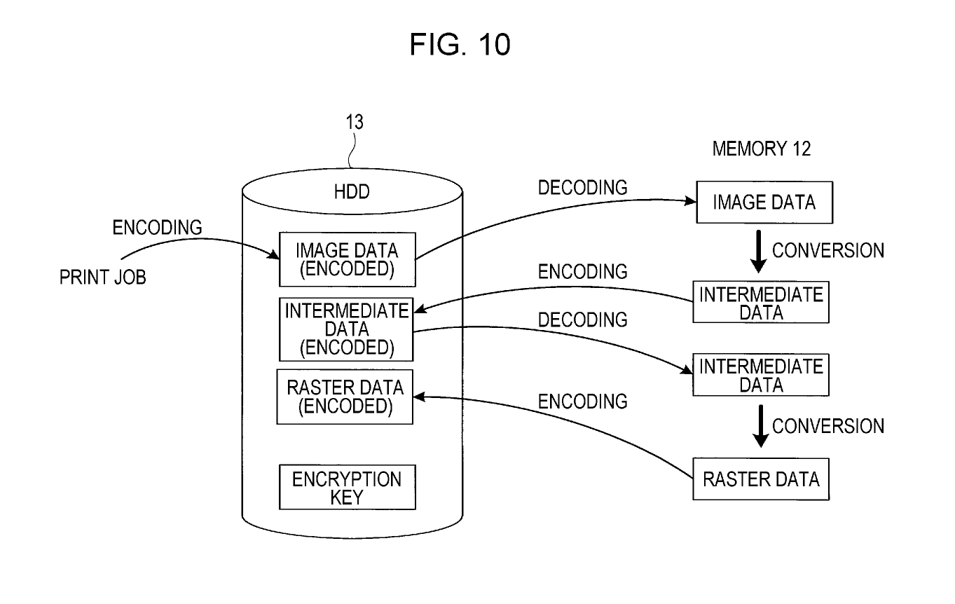

That is, as illustrated in FIG. 10, in a case of storing image data included in a print job in the HDD 13, the image data is encoded and stored. In a case of reading and converting the encoded image data to intermediate data, the read encoded image data is decoded to recover the original data, and the recovered data is loaded to the memory 12. Thereafter, the recovered image data in the memory 12 is converted to intermediate data. The generated intermediate data is encoded by performing a similar process using an encryption key, and thereafter, the encoded intermediate data is stored in the HDD 13.

In a case of reading and converting the encoded intermediate data to raster data, the read encoded intermediate data is decoded to recover the original data, the recovered data is loaded to the memory 12, and the recovered intermediate data in the memory 12 is converted to raster data. The generated raster data is encoded by performing a similar process using the encryption key, and thereafter, the encoded raster data is stored in the HDD 13.

As described above, in a case of storing in the HDD 13 file data based on a print job that is a complete-deletion target, the file data is always encoded by using an encryption key and stored. In a case of reading from the HDD 13 and using the stored file data, the stored file data is decoded by using the encryption key and used.

In order to perform an exclusive OR operation with an encryption key, only a logical circuit needs to be configured. Therefore, the encoding process and the decoding process almost cause no loss of time.

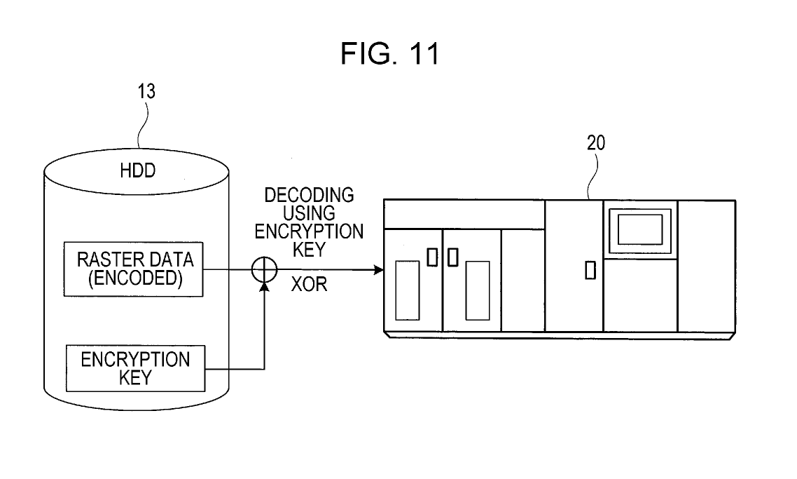

In a case of performing a print process in the print apparatus 20 by using raster data spooled in the HDD 13, the raster data stored in the HDD 13 needs to be read, a decoding process using an encryption key needs to be performed for the raster data, and thereafter, the decoded raster data needs to be transmitted to the print apparatus 20, as illustrated in FIG. 11.

The encoded raster data may be transmitted to the print apparatus 20 as is together with encryption key information, and a decoding process for the raster data may be performed in the print apparatus 20.

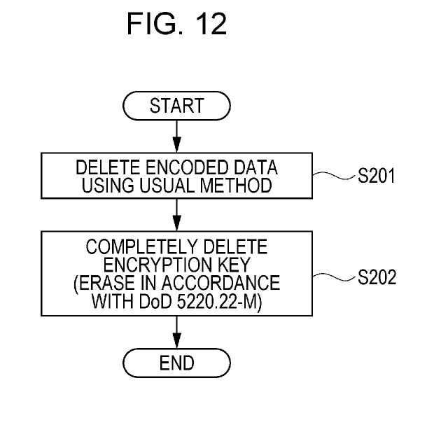

In a case of performing a deletion process for deleting complete-deletion target data from the HDD 13 after completion of a print process, the control unit 32 performs a deletion process by using methods as illustrated in the flowchart in FIG. 12.

That is, the control unit 32 performs a deletion process using a usual method for encoded data (step S201), and performs a deletion process using a complete-deletion method, such as an erase method compliant with, for example, the US Department of Defense standard (DoD 5220.22-M), for the encryption key (step S202).

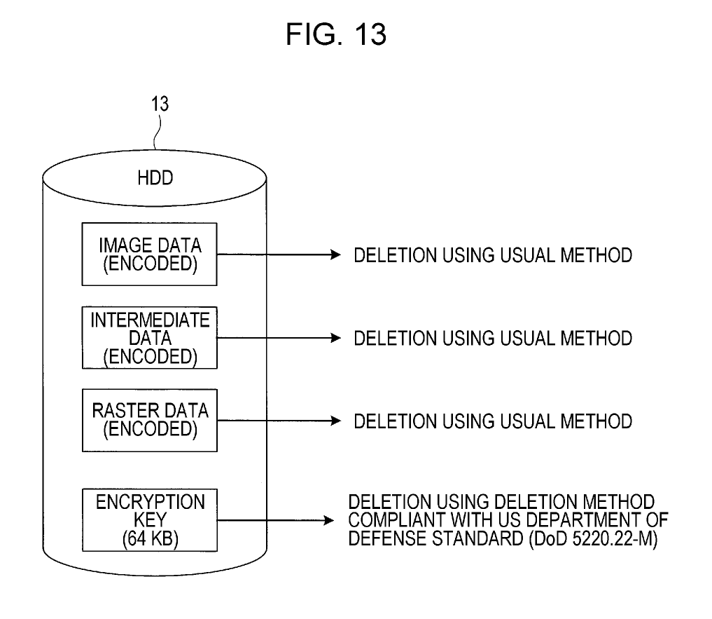

Specifically, as illustrated in FIG. 13, a deletion process is performed for encoded image data, encoded intermediate data, and encoded raster data stored in the HDD 13 by using a usual method, and a deletion process is performed for an encryption key by using a complete-deletion method.

Therefore, in a case where the HDD 13 is taken away after a print process has been performed, even if an attempt is made to recover image data, intermediate data, and raster data that are encoded, print content is less likely to be compromised because these pieces of data are encoded. The encryption key that is used to recover the pieces of file data, which are encoded, is completely deleted, and therefore, recovery of the pieces of file data is hardly possible.

Therefore, even if a malicious third party takes away the HDD 13 and attempts to know print content, the third party has little chance to know the content.

In this exemplary embodiment, when a print process based on one print job is completed, only the encryption key needs to be completely deleted. Therefore, it is possible to complete the deletion process in a short time and to perform the next print job. Encoded image data, encoded intermediate data, and encoded raster data are deleted by using a usual method. Thereafter, at a timing when a print job is not performed and a sufficient processing capacity is available, a deletion process using a complete-deletion method as described above is performed for the pieces of data.

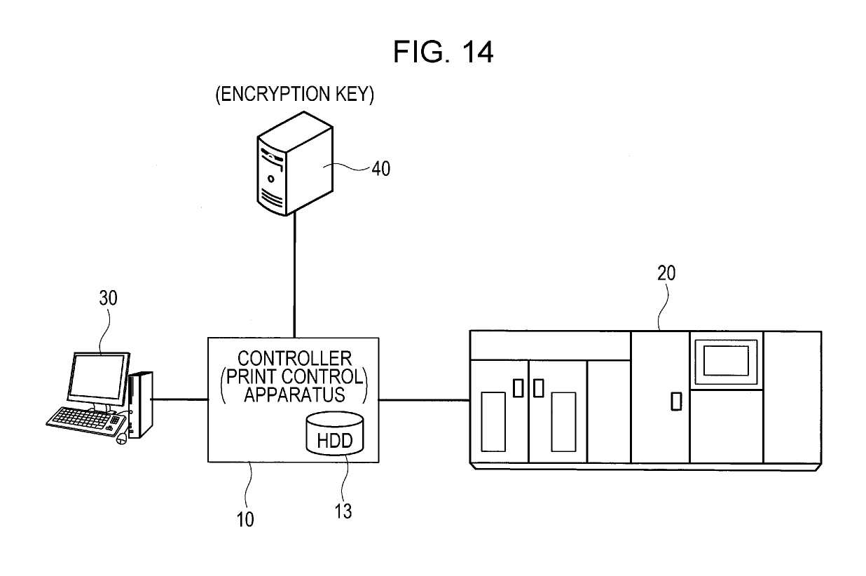

In the above description, the case where an encryption key is saved by storing the encryption key in the HDD 13 has been described. Alternatively, an encryption key may be saved in an external apparatus, such as a server apparatus 40, as illustrated in FIG. 14. Accordingly, even in a state where raster data is spooled in the HDD 13 for a long time, it is possible to suppress the occurrence of a situation where the HDD 13 is taken away and print content is compromised.

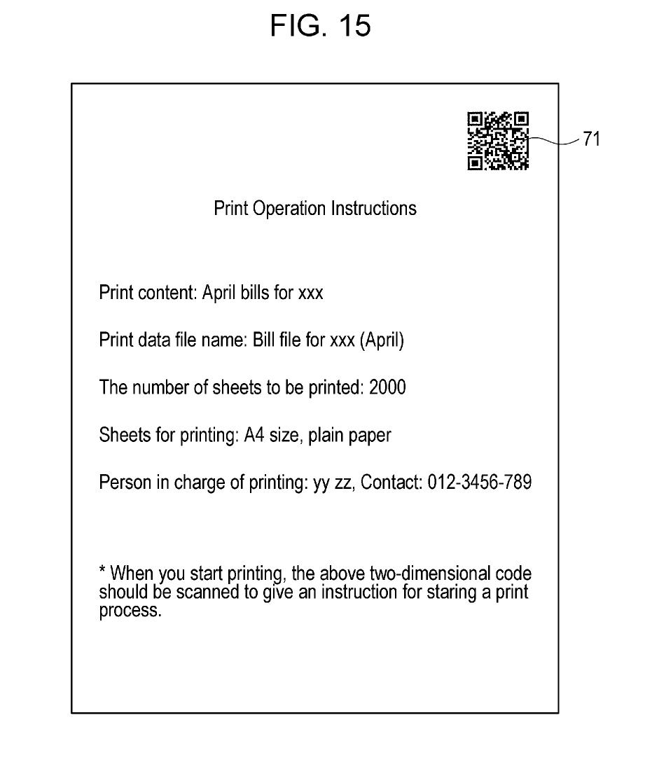

Alternatively, in a state where raster data is stored in the HDD 13, the encryption key may be converted to a two-dimensional code, and the two-dimensional code may be output to a sheet without storing the encryption key on an external apparatus. For example, an output example illustrated in FIG. 15 illustrates a case where an encryption key is output to a sheet of print operation instructions as a two-dimensional code 71.

Accordingly, in a case of performing a print process, the two-dimensional code 71 is scanned by using, for example, a scanner and converted to the encryption key to thereby allow a print process based on the encoded raster data to be performed.

### Modification

In the above description, the case has been described where the exemplary embodiment of the present invention is applied to the print system constituted by the controller 10 and the print apparatus 20, which are provided as separate apparatuses; however, the exemplary embodiment of the present invention is not limited to this. The exemplary embodiment of the present invention is applicable also to an image forming apparatus, such as a multifunction peripheral, which is a single apparatus that implements plural functions, such as a scan function, a print function, and a copy function, or a print apparatus that includes the functions of the controller 10.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a nonvolatile storage unit that stores data;
an acceptance unit that accepts a print instruction including image data;
a conversion unit that converts the image data to print data that is used when a print process is performed; and
a controller that, in a case where the print instruction accepted by the acceptance unit includes a setting indicating that data is to be deleted so as to be unrecoverable, performs control to encode the image data and the print data obtained as a result of conversion by the conversion unit by using encryption key information and to store the image data and the print data in the storage unit.

2. The image processing apparatus according to claim 1, wherein
in a case of deleting the print data and the image data stored in the storage unit, the controller deletes the print data and the image data by using a usual deletion method, and deletes the encryption key information so as to be unrecoverable.

3. The image processing apparatus according to claim 2, wherein
the controller performs a process for deleting the print data and the image data and a process for deleting the encryption key information at different timings.

4. The image processing apparatus according to claim 1, wherein
the controller stores the encryption key information in the storage unit and, in a case of reading the image data or the print data stored in the storage unit, decodes the image data or the print data by using the encryption key information stored in the storage unit.

5. The image processing apparatus according to claim 2, wherein
the controller stores the encryption key information in the storage unit and, in a case of reading the image data or the print data stored in the storage unit, decodes the image data or the print data by using the encryption key information stored in the storage unit.

6. The image processing apparatus according to claim 3, wherein
the controller stores the encryption key information in the storage unit and, in a case of reading the image data or the print data stored in the storage unit, decodes the image data or the print data by using the encryption key information stored in the storage unit.

7. The image processing apparatus according to claim 1, wherein
the controller saves the encryption key information in a location external to the image processing apparatus and, in a case of reading the image data or the print data stored in the storage unit, decodes the image data or the print data by obtaining and using the encryption key information saved in the location external to the image processing apparatus.

8. The image processing apparatus according to claim 2, wherein
the controller saves the encryption key information in a location external to the image processing apparatus and, in a case of reading the image data or the print data stored in the storage unit, decodes the image data or the print data by obtaining and using the encryption key information saved in the location external to the image processing apparatus.

9. The image processing apparatus according to claim 3, wherein
the controller saves the encryption key information in a location external to the image processing apparatus and, in a case of reading the image data or the print data stored in the storage unit, decodes the image data or the print data by obtaining and using the encryption key information saved in the location external to the image processing apparatus.

10. The image processing apparatus according to claim 7, wherein
the controller outputs the encryption key information to a sheet as a two-dimensional code image and, in a case of reading the image data or the print data stored in the storage unit, decodes the image data or the print data by using the encryption key information obtained from image data obtained by reading the two-dimensional code image.

11. The image processing apparatus according to claim 8, wherein
the controller outputs the encryption key information to a sheet as a two-dimensional code image and, in a case of reading the image data or the print data stored in the storage unit, decodes the image data or the print data by using the encryption key information obtained from image data obtained by reading the two-dimensional code image.

12. The image processing apparatus according to claim 9, wherein
the controller outputs the encryption key information to a sheet as a two-dimensional code image and, in a case of reading the image data or the print data stored in the storage unit, decodes the image data or the print data by using the encryption key information obtained from image data obtained by reading the two-dimensional code image.

13. The image processing apparatus according to claim 1, wherein
in a case where the print instruction includes the setting indicating that data is to be deleted so as to be unrecoverable, the controller assumes that the image data included in the print instruction and the print data that is generated are targets to be deleted so as to be unrecoverable, and assumes that print setting information included in the print instruction is not a target to be deleted so as to be unrecoverable.

14. The image processing apparatus according to claim 1, wherein
the controller performs an exclusive OR operation for the encryption key information and the image data or for the encryption key information and the print data to thereby encode the image data or the print data, and performs an exclusive OR operation for the encryption key information and the encoded image data or for the encryption key information and the encoded print data to thereby decode the encoded image data or the encoded print data.

15. A print system comprising:
an image processing apparatus including
a nonvolatile storage unit that stores data,
an acceptance unit that accepts a print instruction including image data,
a conversion unit that converts the image data to print data that is used when a print process is performed, and
a controller that, in a case where the print instruction accepted by the acceptance unit includes a setting indicating that data is to be deleted so as to be unrecoverable, performs control to encode the image data and the print data obtained as a result of conversion by the conversion unit by using encryption key information and to store the image data and the print data in the storage unit; and
an image forming apparatus that forms an image on a recording medium on the basis of the print data generated in the image processing apparatus.

16. A non-transitory computer readable medium storing a program causing a computer to execute a process for image processing, the process comprising:
accepting a print instruction including image data;
encoding, by using encryption key information, and storing, in a nonvolatile storage unit for storing data, the image data in a case where the print instruction accepted in the accepting includes a setting indicating that data is to be deleted so as to be unrecoverable;
converting the image data to print data that is used when a print process is performed; and
encoding, by using the encryption key information, and storing, in the storage unit, the print data obtained as a result of conversion in the converting.
